(19) United States
(12) Patent Application Publication
(10) Pub. No.: US 2010/0259799 A1
(43) Pub. Date: Oct. 14, 2010

(54) IMAGE PROCESSING APPARATUS, CONTROL METHOD FOR IMAGE PROCESSING APPARATUS, AND STORAGE MEDIUM STORING CONTROL PROGRAM THEREFOR

(75) Inventor: Koki Shibao, Yokohama-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/755,573

(22) Filed: Apr. 7, 2010

(30) Foreign Application Priority Data
Apr. 8, 2009 (JP) 2009-094029

(51) Int. Cl. H04N 1/04

(52) U.S. Cl. 358/448; 358/474

(57) ABSTRACT

An image processing apparatus that is capable of avoiding a mistake of transmitting a scan image read by pseudo-push scanning method to a wrong transmitting destination. A display unit displays a selection screen on which a scan setting and a transmitting destination of the scan image are selected. A first transmission unit transmits the selected information and a transmitting request of reading-start-instruction information about the image. A reading unit reads an image of an original upon receiving the transmitted reading-start-instruction information. A second transmission unit transmits the read scan image. When the scan image is transmitted from the information processing apparatus to the other device and stored, the storage destination information about the scan image includes information about the information processing apparatus and another device. In that case, the display unit displays the information processing apparatus and the other device as the transmitting destination.

### BACKGROUND OF THE INVENTION

1. Field of the Invention

The present invention relates to an image processing apparatus such as a scanner or an MFP that has a function to transmit a read image to an information processing apparatus such as a PC. The present invention also relates to a control method for the image processing apparatus, and a storage medium storing a control program therefor.

1. Description of the Related Art

An image processing apparatus such as a scanner or an MFP may use pseudo-push scanning (PushScan) method, when transmitting an image read by a reading unit.

According to the pseudo-push scanning method, an MFP transmits a request to perform pull scanning by itself to an information processing apparatus such as a host PC that has pull scanning (PullScan) driver, and the host PC makes the MFP perform a scan, for example.

The image scanned by the MFP is transmitted to the host PC, and the host PC stores the received image into its own memory or a memory of another PC based on storage destination information about the image set up beforehand. With these steps, the scanned image is transmitted (stored) to a desired host PC designated by the MFP, which artificially achieves the push scan from the MFP.

Since this pseudo-push scanning method does not require the MFP to support a plurality of communication protocols and to set complicated network settings, a cost is reduced and a usability is improved as compared with an MFP that performs the push scan on a stand-alone basis (see Japanese laid-open patent publication (Kokai) No. 2003-198819 (JP2003-198819A)).

Conventionally, when the pseudo-push scanning is performed from the MFP side, a user selects one name from among host PC names and names assigned to scan setting at the host PC side displayed on a display unit of the MFP.

However, in the above-mentioned conventional technique, when the pseudo-push scanning is performed from the MFP side, the display unit of the MFP merely displays the host PC names and the names assigned to the scan setting at the host PC side.

Accordingly, since it is difficult to determine which host PC is a final transmitting destination based on the information displayed on the display unit of the MFP, there is a possibility of transmitting an image to a wrong transmitting destination from the MFP.

Since a transmission path of an image is not apparent from the information displayed on the display unit of the MFP, it takes much time to fix a problem when an error occurs.

### SUMMARY OF THE INVENTION

The present invention provides an image processing apparatus, a control method therefor, and a storage medium storing a control program therefor, which are capable of avoiding a mistake of transmitting a scan image read by the pseudo-push scanning method to a wrong transmitting destination. Further, the present invention provides the image processing apparatus, the control method therefore, and the storage medium storing the control program therefore which are capable of specifying a problem easily when an error occurs.

Accordingly, a first aspect of the present invention provides an image processing apparatus comprising a display unit adapted to display a selection screen on which a user selects a scan setting and a transmitting destination of a scan image based on scan setting information and storage destination information about an image transmitted from an information processing apparatus, a first transmission unit adapted to transmit the information selected on the selection screen and a transmitting request of reading-start-instruction information about the image to the image processing apparatus, a reading unit adapted to read an image of an original in response to receiving the reading-start-instruction information transmitted from the information processing apparatus, and a second transmission unit adapted to transmit a scan image of the original read by the reading unit to the information processing apparatus, wherein the storage destination information about the image transmitted from the information processing apparatus includes information about the information processing apparatus and another device, when the scan image is transmitted from the information processing apparatus to the other device and stored, wherein the display unit displays the information processing apparatus and the other device as the transmitting destination on the selection screen, when the storage destination information includes the information about the information processing apparatus and the other device.

Accordingly, a second aspect of the present invention provides a control method for an image processing apparatus comprising a display step of displaying a selection screen on which a user selects a scan setting and a transmitting destination of a scan image based on scan setting information and storage destination information about an image transmitted from an information processing apparatus, a first transmission step of transmitting the information selected on the selection screen and a transmitting request of reading-start-instruction information about the image to the image processing apparatus a reading step of reading an image of an original in response to receiving the reading-start-instruction information transmitted from the information processing apparatus, and a second transmission step of transmitting a scan image of the original read in the reading step to the information processing apparatus, wherein the storage destination information about the image transmitted from the information processing apparatus includes information about the information processing apparatus and another device, when the scan image is transmitted from the information processing apparatus to the other device and stored, wherein the display step displays the information processing apparatus and the other device as the transmitting destination on the selection screen, when the storage destination information includes the information about the information processing apparatus and the other device.

Accordingly, a third aspect of the present invention provides a computer-readable storage medium storing a control program executing a control method for an information processing apparatus, the control method comprising a display step of displaying a selection screen on which a user selects a scan setting and a transmitting destination of a scan image based on scan setting information and storage destination information about an image transmitted from an information processing apparatus, a first transmission step of transmitting the information selected on the selection screen and a transmitting request of reading-start-instruction information about the image to the image processing apparatus, a reading step of reading an image of an original in response to receiving the reading-start-instruction information transmitted from the information processing apparatus, and a second transmission step of transmitting a scan image of the original read in the reading step to the information processing apparatus, wherein the storage destination information about the image transmitted from the information processing apparatus includes information about the information processing apparatus and another device, when the scan image is transmitted from the information processing apparatus to the other device and stored, wherein the display step displays the information processing apparatus and the other device as the transmitting destination on the selection screen, when the storage destination information includes the information about the information processing apparatus and the other device.

According to the present invention, the mistake of transmitting a scan image read by the pseudo-push scanning method to a wrong transmitting destination can be avoided. Further, a problem can be easily specified when an error occurs.

Further features of the present invention will become apparent from the following description of exemplary embodiments with reference to the attached drawings.

### BRIEF DESCRIPTION OF THE DRAWINGS

FIG. 1 is a view schematically showing a system configuration of an MFP as an image processing apparatus of a first embodiment according to the present invention.

FIG. 2 is a block diagram schematically showing a configuration of a control unit of the MFP in FIG. 1.

FIG. 3 is a block diagram schematically showing an accumulation process of a scan image read by a CCD or a CIS of the MFP in FIG. 1.

FIG. 4 is a view showing an example of an operation-display unit of the MFP in FIG. 1.

FIG. 5 is a view showing a screen example displayed on a display unit of a host PC in FIG. 1 when performing pull scanning from the host PC.

FIG. 6 is a view showing a screen example displayed on the display unit of the host PC in FIG. 1 when a setting key in the screen shown in FIG. 5 is pressed.

FIG. 7 is a view showing a basic sequence among the MFP, the host PC, and a client PC in FIG. 1.

FIG. 8 is a view showing examples of selection screens displayed on a display unit of the MFP in FIG. 1 when a menu of pseudo-push scanning is selected by a user's operation.

FIG. 9 is a flowchart showing an operation example of the MFP in FIG. 1.

FIG. 10 is a flowchart showing an operation example of the host PC in FIG. 1.

FIG. 11 is a view schematically showing a system configuration of an MFP as an image processing apparatus of a second embodiment according to the present invention.

FIG. 12 is a view showing a screen example of a custom scan setting of pull scanning displayed on a display unit of a host PC in FIG. 11.

FIG. 13 is a view showing examples of selection screens displayed on a display unit of the MFP in FIG. 11 when a menu of pseudo-push scanning is selected by a user's operation.

FIG. 14 is a view schematically showing a system configuration of an MFP as an image processing apparatus of a third embodiment according to the present invention.

### DESCRIPTION OF THE EMBODIMENTS

Hereafter, embodiments according to the present invention will be described in detail with reference to the drawings.

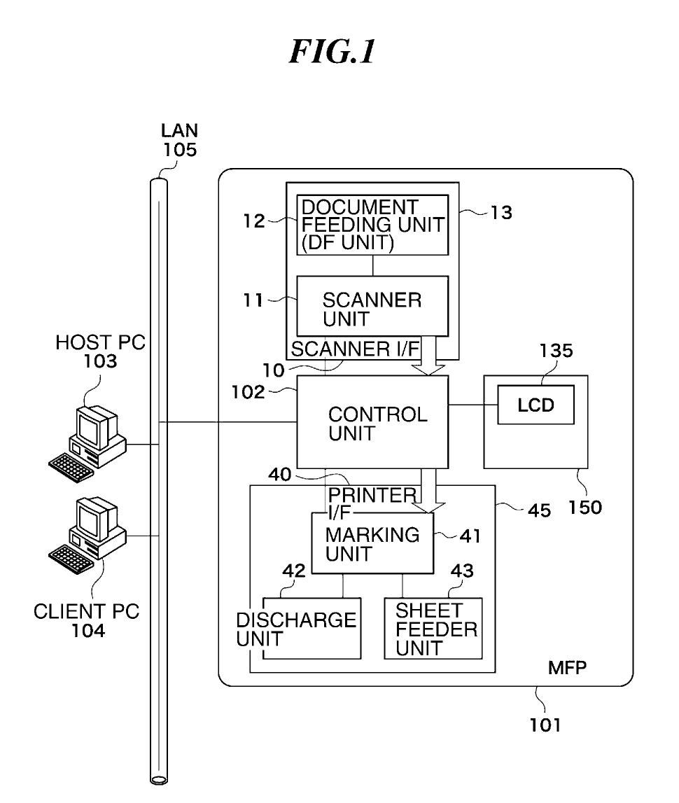

FIG. 1 is a view schematically showing a system configuration of an MFP as an image processing apparatus of a first embodiment according to the present invention.

As shown in FIG. 1, the MFP 101 of this embodiment is provided with a reading unit 13, an image output unit 45, a control unit 102, and an operation-display unit 150, and is connected with information processing apparatuses such as a host PC 103 and a client PC 104 via a network 105 such as a LAN so as to enable communication.

The reading unit 13 comprises a scanner unit 11 having a function to read an image of an original, and a document feeder unit 12 having a function to feed an original. The reading unit 13 reads an image of an original optically, and converts it into image data.

The image output unit 45 comprises a sheet feeder unit 43 having a plurality of kinds of recording paper cassettes, a marking unit 41 having a function to transfer and fix image data onto a recording paper, and an discharge unit 42 having a function to sort and staple a printed recording paper and to output to outside of the apparatus.

The control unit 102 provides a copy function for controlling the reading unit 13 to read image data of an original and for controlling the image output unit 45 to output the read image data onto a recording paper. The control unit 102 provides a function to transmit the image data read by the reading unit 13 to the host PC 103 etc. via the network 105.

The operation-display unit 150 comprises an LCD unit 135, hardkeys, etc., and provides a user I/F for operating the MFP 101.

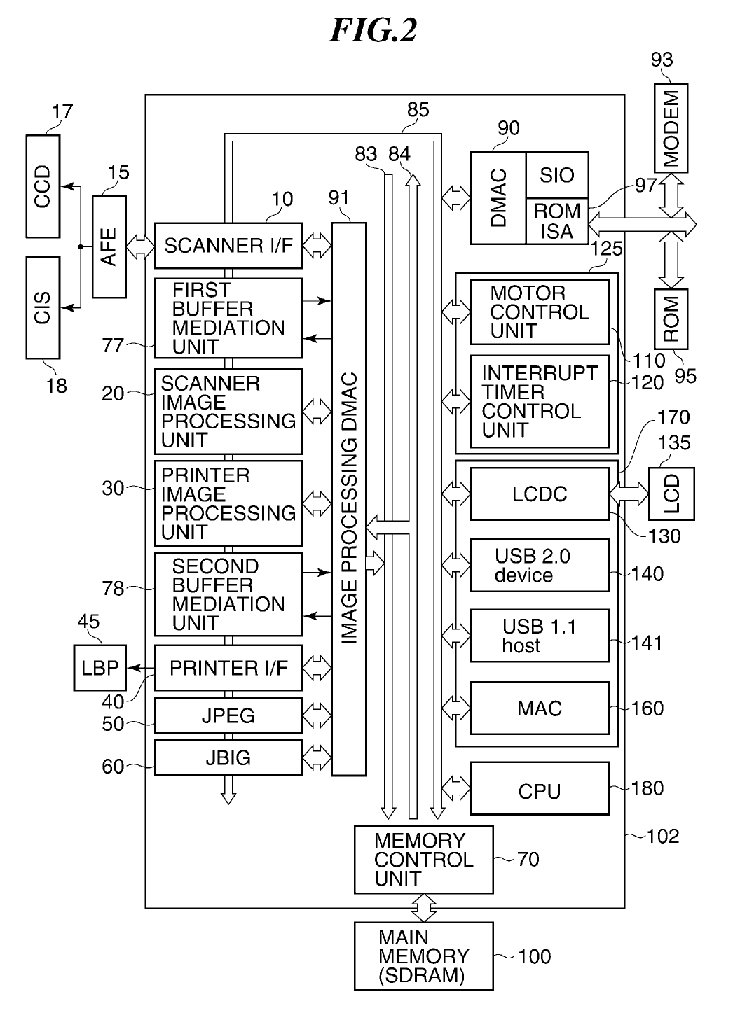

FIG. 2 is a block diagram schematically showing a configuration of the control unit 102 of the MFP 101 shown in FIG. 1.

In FIG. 2, a CCD 17 and a CIS 18 are connected to a scanner I/F 10 via an AFE (analog front end) 15. The scanner I/F 10 performs an input process to read image signals from the CCD 17 and the CIS 18. The input image data is transferred with a DMA by a memory control unit 70 and is developed onto a main memory 100.

A scanner image processing unit 20 executes an image process corresponding to an image processing operation mode (a color copy, a monochrome copy, a color scan, a monochrome scan, etc.) to the image data developed onto the main memory 100 according to the process by the scanner I/F 10.

A first buffer mediation unit 77 mediates between writing of data and reading of data when receiving/transmitting data between the scanner I/F 10 and the scanner image processing unit 20 via a ring buffer area on the main memory 100.

A printer image processing unit 30 performs an area edit and a resolution transform process to input image data, and outputs the processed image data to a printer. A printer I/F 40 outputs a result of the image process to the image processing unit (LBP) 45.

A second buffer mediation unit 78 mediates between writing of data and reading of data when receiving/transmitting data between the printer image processing unit 30 and the printer I/F 40 via the ring buffer area on the main memory 100. Although basic configurations of the first and second buffer mediation units 77 and 78 are identical, control methods are different with applications.

A JPEG module 50 and a JBIG module 60 execute compression/expansion processes to image data in conformity with a predetermined standard.

The memory control unit 70 is connected with first and second buses 83 and 84 for an image processing system, and a third bus 85 for a computer system. The memory control unit 70 controls data transmission for writing/reading data to/from the main memory (SDRAM) 100.

A DMAC (DMA controller) 90 is connected with a ROM 95 via a ROMISA 97 in cooperation with the memory control unit 70. The DMAC 90 generates and sets up predetermined address information for the DMA control about receiving/transmitting data between an external device or various interface control units in an interface group 170 and the main memory 100.

An image-processing DMAC 91 generates and sets up predetermined address information for the DMA control about receiving/transmitting data between the interfaces 10 and 40, the image processing units 20 and 30 and the main memory 100 in cooperation with the memory control unit 70.

For example, the image-processing DMAC 91 generates address information for each channel of the DMA for performing DMA transfer of the image data read by the COD 17 or the CIS 18 via the scanner I/F 10 to the main memory 100. The image-processing DMAC 91 manages the DMA control, which is the DMA transfer of the image data developed onto the main memory 100 to the scanner image processing unit 20, for example, between the interfaces 10 and 40, the image processing units 20 and 30 and the main memory 100 in cooperation with the memory control unit 70.

The ROM 95 stores a control parameter, control program data, etc., corresponding to the CCD 17 and the CIS 18. This enables an input process of image data corresponding to individual data output formats of the CCD 17 and the CIS 18, which does not need an interface circuitry for exclusive use.

The first bus 83 transmits data read from the main memory 100 to the processing units 10, 20, 30, 40, 50, and 60 of the image processing system. The second bus 84 transmits data read from the processing units 10, 20, 30, 40, 50, and 60 of the image processing system to the main memory 100. The first bus 83 and the second bus 84 receive/transmit image data between the image processing system and the main memory 100 as a pair. The third bus 85 is a bus for the computer system to connect a CPU 180, the interface group 170, a mechatronics system control unit 125, a control register of the image processing system, and the DMAC 90.

The mechatronics system control unit 125 includes a motor control unit 110 and an interruption timer control unit 120 that controls driving timing for a motor and timing for synchronizing processes by the image processing system.

An LCD control unit 130 manages display control for displaying various settings, process conditions, etc., on the LCD unit 135. USB interfaces 140 and 141 are used to connect peripheral devices. A MAC (media access) control unit 160 controls, for example, timing to transmit data to a connection device, and is also used when communicating with other devices (the host PC103, the client PC 104, etc.) via the network 105. The CPU 180 manages the entire control of the MFP 101.

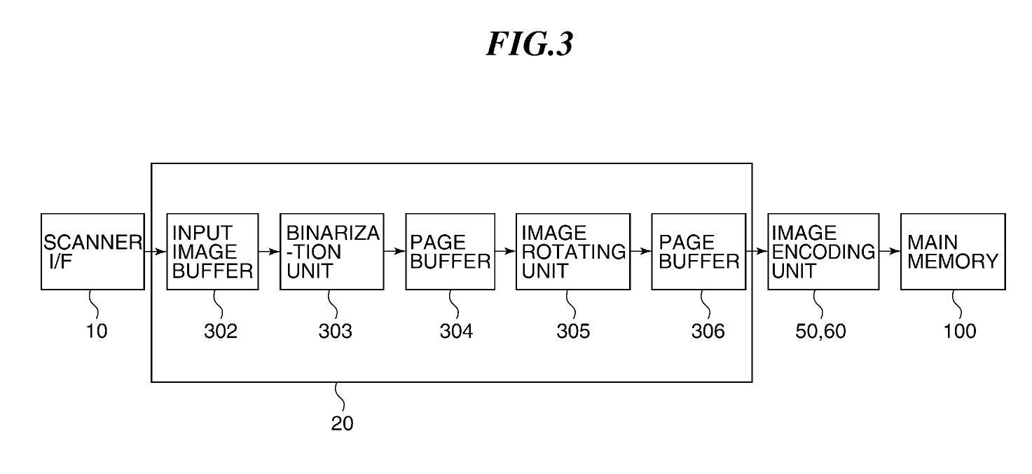

Next, an accumulation process of scan images read by the CCD 17 or the CIS 18 of the MFP 101 will be described with reference to FIG. 3.

Image data of an original scanned by the CCD 17 or the CIS 18 is accumulated in an input image buffer 302 of the scanner image processing unit 20 via the scanner I/F 10, after the AFE 15 applies an A/D-conversion process etc. At this time, the image data is treated as a binary format (one byte per pixel) in a case of monochrome, as a multilevel format (three bytes per pixel) in a case of color. The input image buffer 302 does not need to allocate a full page memory space, and is enough to allocate a memory space corresponding to a process unit of a binarization process performed by a binarization unit 303 in the next process.

The binarization unit 303 converts a multilevel image into a binary image for every fixed amount of data, and stores the converted data into a page buffer 304.

Next, when a user operates the operation-display unit 150 to set up image rotation control (for example, the presence or absence of rotation, a direction and an angle of rotation, etc.), the CPU 180 controls an image rotation unit 305 to perform an image rotation process according to the setting via the third bus 85. The image to which the image rotation process has been applied is stored in a page buffer 306. Then, the binary image stored in the page buffer 306 is encoded by the JBIG module 60 in the case of monochrome, or is encoded by the JPEG module 50 in the case of color. In any case, the encoded image is stored in the main memory 100.

In this embodiment, when performing pull scanning or pseudo-push scanning, since the host PC 103 executes much of the image process, neither the image rotation by the image rotation unit 305 nor the encoding process is performed, the scan picture is stored in the main memory 100 as is. It should be noted that the scan image can be stored in an HDD according to a hardware configuration.

Next, a transmitting process of an image from the MFP 101 will be described.

The CPU 180 executes a control program to achieve a protocol and a transmitting specification stored in the ROM 95. Specifically, the CPU 180 encodes image data stored in the main memory 100, adds a packet header, etc., and transmits the image data to the host PC 103, for example, from the third bus 85 via the network 105 such as the LAN. It should be noted in this embodiment, the TCP/IP is used to provide communications for performing pseudo-push scanning on the TCP/IP. A sequence for the pseudo-push scanning will be described below.

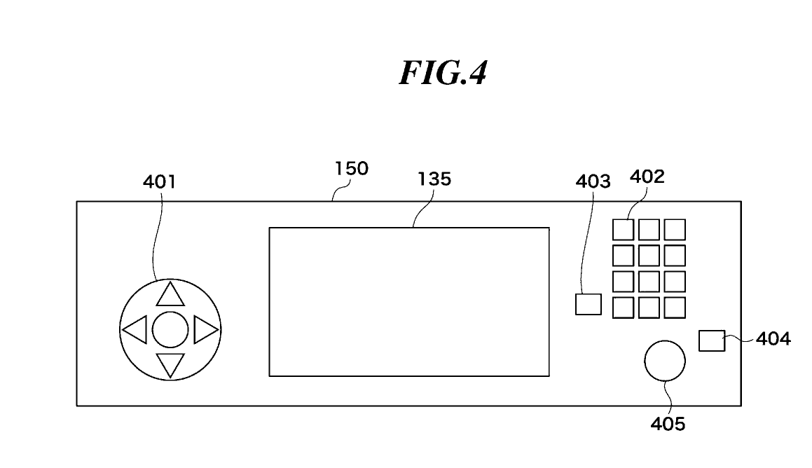

Next, an example of a screen of the operation-display unit 150 will be described with reference to FIG. 4.

As shown in FIG. 4, the LCD unit 135, menu selection keys 401, a ten-digit keypad 402, a reset key 403, a stop key 404, and a start key 405 are arranged on the operation-display unit 150.

The menu selection keys 401 comprises keys to scroll a cursor in the four directions (up, down, right, and left directions) for selecting an item in a menu displayed on the LCD unit 135, and a key to fix the selected item. The ten-digit keypad 402 is used to input a numeric value such as a number of copies. The reset key 403 is used to clear the setting condition and to return the condition to an initial value. The start key 405 is used to give an instruction to start various jobs. The stop key 404 is used to give an instruction to stop a started job.

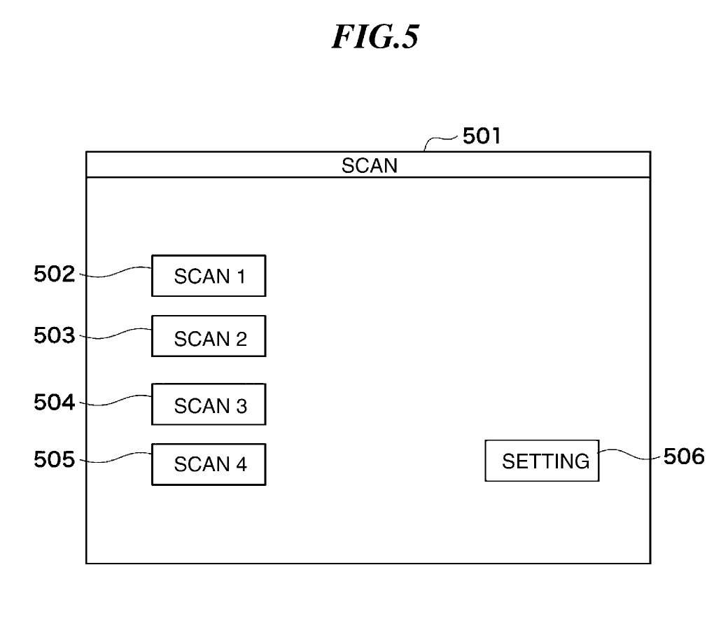

Next, a read setting by a driver of the host PC 103 will be described with reference to FIG. 5.

When performing pull scanning from the host PC 103, a screen 501 in which buttons 502 through 505 and a setting key 506 are arranged is displayed on a display unit (not shown) of the host PC 103. Custom scan settings that define reading methods are respectively assigned to the buttons 502 through 505. And when one of the buttons 502 through 505 is pushed, the MFP 101 starts reading an original and transmits image data read to the host PC 103.

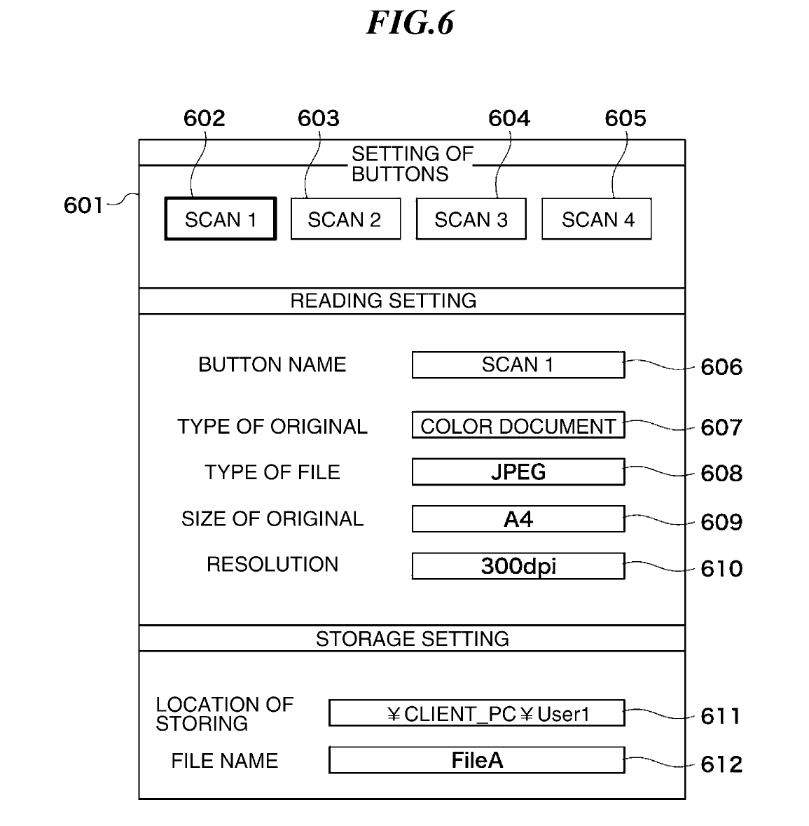

When the setting key 506 is pushed, the host PC 103 displays a screen 601 shown in FIG. 6 on the display unit of the host PC 103. A plurality of buttons 602 through 605 are arranged in the screen 601. For example, when the button 602 is pushed, the custom setting of a “SCAN 1” key will be performed. As a result of this selecting operation, setting values, which were set by a user as default setting values, are displayed in fields 606 through 612. The user is able to change these values to desired values.

For example, a name of the custom scan key can be changed in the field 606. Although mentioned later, if a name of a key is changed here, the changed key name is reflected to the indication in the LCD unit 135 of the MFP 101.

In the field 607, a type of an original at the time of reading can be selected. There are a color document, a monochrome document, etc. as choices. In the field 608, a file format at the time of storing can be selected from among JPEG, TIFF, PDF, BMP, and the like. In the field 609, a size of an original to be scanned can be specified.

In the field 610, resolution of a image to be scanned can be specified. In the field 611, a location (a path) where an image is stored can be specified. In the field 612, a name of a stored file can be specified.

As mentioned above, the image process is performed to a scan image based on the setting values in the fields 607 through 610 and a desired image is obtained. The image process may be performed by either the MFP 101 or the host PC 103. In this embodiment, it is assumed that the host PC performs the image process.

It should be noted that an image is transmitted when the MFP 10 side requests a start of the pull scanning, i.e., a depression of one of the buttons 502 through 505 in the screen 501 in FIG. 5, from the host PC 103.

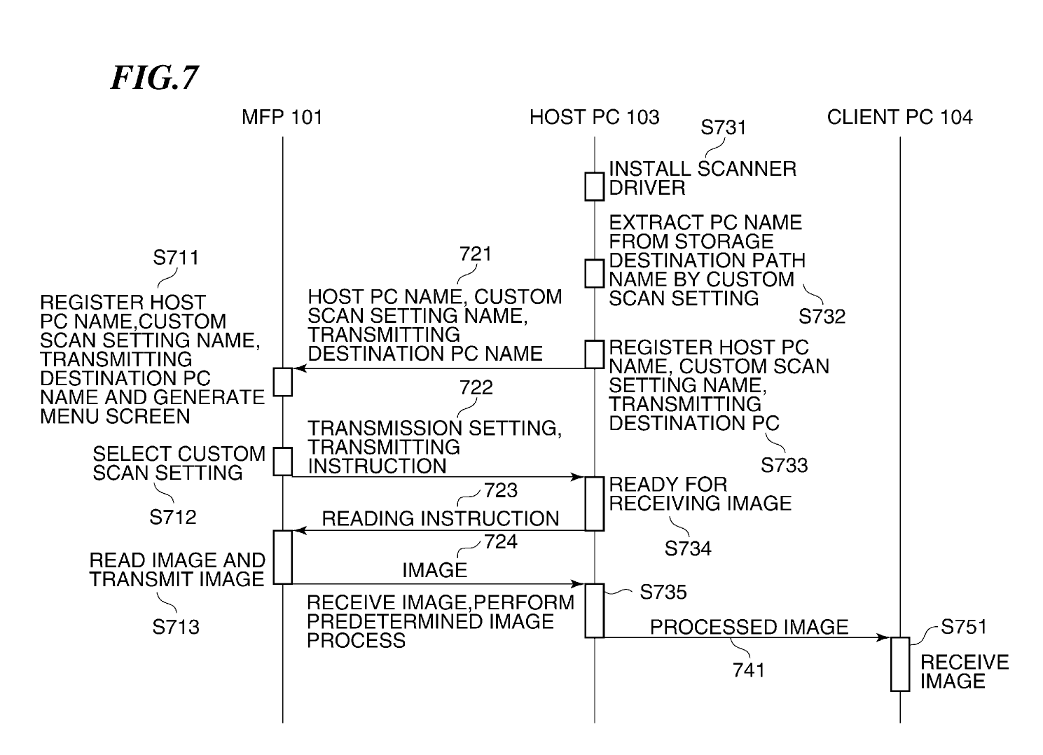

Next, a basic sequence among the MFP 101, the host PC 103, and the client PC 104 will be described with reference to FIG. 7. It should be noted that a folder of the client PC 104 is assumed to be specified by a user in the field 611 of a “location of storing” of the storage setting in the screen 601 for the custom setting in FIG. 6.

In FIG. 7, pull scanning driver is installed in the host PC 103 in step S731. Accordingly, the host PC 103 becomes possible to perform the pull scanning.

In step S732, the host PC 103 generates information 721 to be transmitted to the MFP 101. This step is executed at the timing of installing the driver to the host PC 103, at the timing of starting the host PC 103 starts, at the timing of changing the custom scan setting on the driver, for example. In addition, if the host PC 103 has a multiple user interface as with the Windows (the registered trademark of the Microsoft), the step S732 is executed at the timing of changing a logon user.

In step S733, the host PC 103 transmits the information 721 that is generated in step S732 to the MFP 101. If there are a plurality of custom-scan-setting keys as shown in FIG. 5, the information pieces as many as the keys will be transmitted. The information 721 transmitted from the host PC 103 to the MFP 101 includes a host PC name (storage destination information), a custom scan setting name (scan setting information), and a transmitting destination PC name (storage destination information).

In step S711, the MFP 101 receives the information 721 transmitted from the host PC 103 in the step S733. The MFP 101 displays the received information 721 on the LCD unit 135 as a selection menu screen.

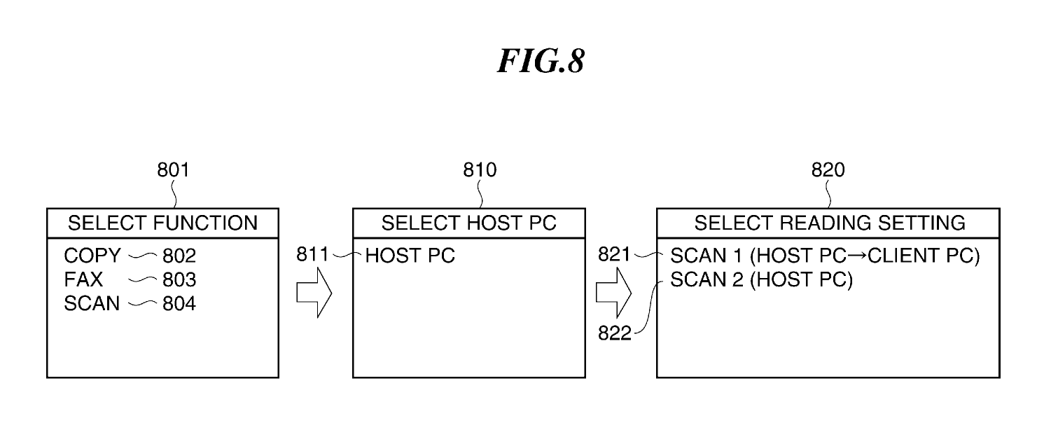

In step S712, the MFP 101 requests a start request for the pull scanning from the host PC 103. At this time, the MFP 101 displays a screen shown in FIG. 8 on the LCD unit 135. The screen in FIG. 8 will be described below. In the step S712, the MFP 101 makes a user select which custom scan setting is used to scan on the LCD unit 135. Then, the MFP 101 transmits the selected information (custom scan setting information) together with a transmitting request of reading-start-instruction information (a transmission instruction) 722 to the host PC 103. This process is an example of a first transmission process in this embodiment.

In step S734, the host PC 103 receives the information 722 from the MFP 101 and starts the pull scanning. At this time, the host PC 103 determines which of the custom scan settings of the buttons 502 through 505 is used to start the pull scanning based on a content of the information 722. And the host PC 103 transmits reading-start-instruction information 723 to the MFP 101 so as to scan with the determined content.

In step S713, the MFP 101 starts scanning an original based on the reading-start-instruction information 723 received, and transmits image data 724 of the scanned original to the host PC 103. This process is an example of a second transmitting process in this embodiment.

In step S735, the host PC 103 receives the image data 724 transmitted in the step S713, and performs the image process based on a parameter of the specified custom scan setting. In this embodiment, since the folder of the client PC 104 is specified as the storage destination, the host PC 103 transmits the processed image 741 to the client PC 104, and the client PC 104 receives the processed image and stores it into a memory etc. in step S751.

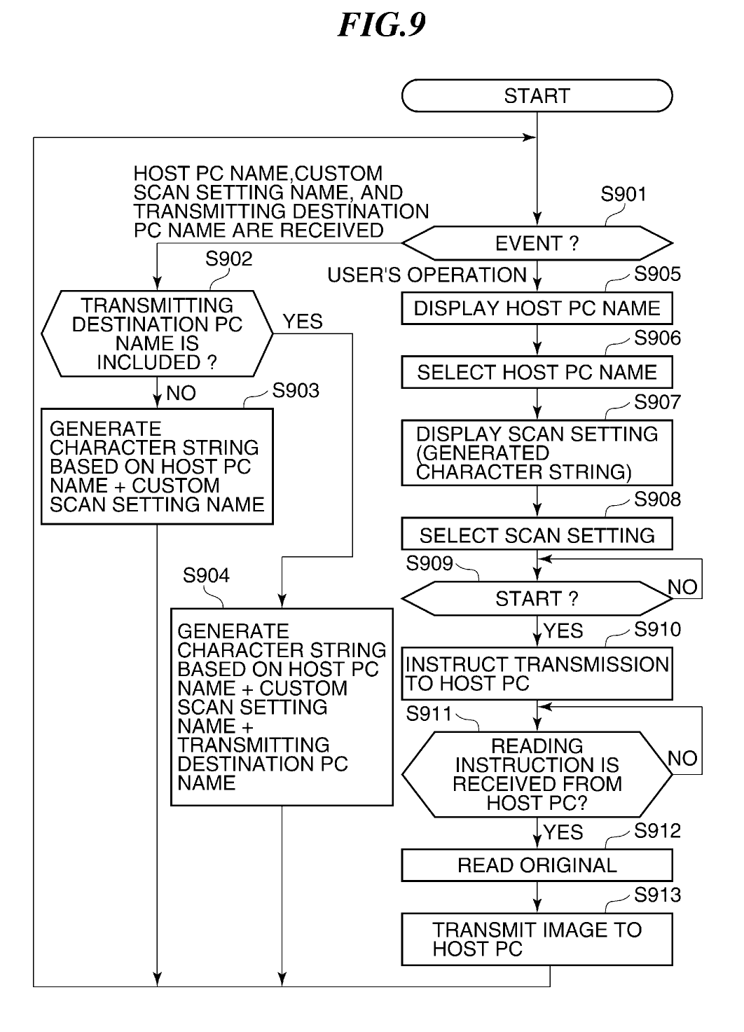

Next, an operation example of the MFP 101 of this embodiment will be described with reference to FIG. 9. It should be noted that each process in FIG. 9 is achieved by loading a control program stored in the ROM 95 or the like of the MFP 101 onto a RAM (not shown) and by executing the program by the CPU 180.

In step S901, the CPU 180 determines a content of an event occurred. That is, the CPU 180 determines whether the information (the host PC name+the custom-scan-setting name+the transmitting destination PC name) is received from the host PC 103 or the item of the pseudo-push scanning is selected in the menu by the user's operation on the operation-display unit 150.

When the CPU 180 determines that the information is received from the host PC 103, the process is proceeded to step S902. When the CPU 180 determines that the item of the pseudo-push scanning is selected in the menu by the user's operation, the process is proceeded to step S905. It should be noted that the information from host PC 103 may not include the transmitting destination PC name.

In the step S902, the CPU 180 determines whether the transmitting destination PC name is included in the information received from the host PC 103. When it is included, the process proceeds to step S904, and when it is not included, the process proceeds to step S903.

In the step S904, the CPU 180 generates a character string to be displayed on the LCD unit 135 based on the host PC name, the custom scan setting name, and the transmitting destination PC name that are defined in the information received from the host PC 103, and returns the process to the step S901.

In the step S903, the CPU 180 generates a character string to be displayed on the LCD unit 135 based on the host PC name and the custom scan setting name that are defined in the information received from the host PC 103, and returns the process to the step S901.

On the other hand, the CPU 180 displays a selection screen 810 of the host PC name shown in FIG. 8 on the LCD unit 135 in the step S905. Specifically, FIG. 8 shows a condition where a scan 804 is selected on a selection screen 801 and the selection screen 810 of the host PC is displayed on the LCD unit 135. The character string of the host PC name 811 generated in the step S903 or the step S904 is displayed on the selection screen 810 as a choice.

In step S906, the CPU 180 detects an input of the menu selection key 401 in FIG. 4, determines which host PC is selected in the selection screen 810, and proceeds with the process to step S907.

In the step S907, the CPU 180 displays the custom scan setting name of the host PC selected in the step S906 on the LCD unit 135.

Specifically, FIG. 8 shows a condition where the host PC name 811 is selected in the selection screen 810 and a selection screen 820 of the custom scan setting (reading setting) is displayed on the LCD unit 135 of the MFP 101.

When the field 611 of the “location of storing” in FIG. 6 shows the host PC, the character string of the custom scan setting name 822 generated in the step S903 is displayed on the selection screen 820 as a choice. When the field 611 of the “location of storing” in FIG. 6 shows other than the host PC (the client PC 104, for example), the character string of the custom scan setting name 821 generated in the step S904 is displayed on the selection screen 820 as a choice.

The choice generated in the step S903 includes only the host PC name without the transmitting destination PC name of an image like the item 822 (SCAN 2) in FIG. 8. The choice generated in the step S904 includes the host PC name and the transmitting destination PC name of an image like the item 821 (SCAN 1) in FIG. 8.

Next, in step S908, the CPU 180 detects an input of the menu selection key 401 in FIG. 4, determines which reading setting (custom scan setting) is selected in the selection screen 820, and proceeds with the process to step S909.

In the step S909, the CPU 180 waits an input of the start key 405 in FIG. 4. When detecting the input, the process proceeds to step S910.

In the step S910, the CPU 180 transmits the custom scan setting determined in the step S908 and the information about the transmission instruction to the host PC 103 so as to make the own device (the MFP 101) perform the pull scanning.

In step S911, the CPU 180 waits an instruction of the pull scanning from the host PC 103. When receiving the instruction, process proceeds to step S912.

In the step S912, the CPU 180 controls the CCD 17 or the CIS 18 to read an image of an original, executes the accumulation process of the scanned image data to the main memory 100 described in FIGS. 3, and proceeds with the process to step S913.

In the step S913, as mentioned above, the CPU 180 transmits the scanned image data accumulated in the main memory 100 to the host PC 103 from the third bus 85 via the network 105 such as the LAN, and returns the process to the step S901.

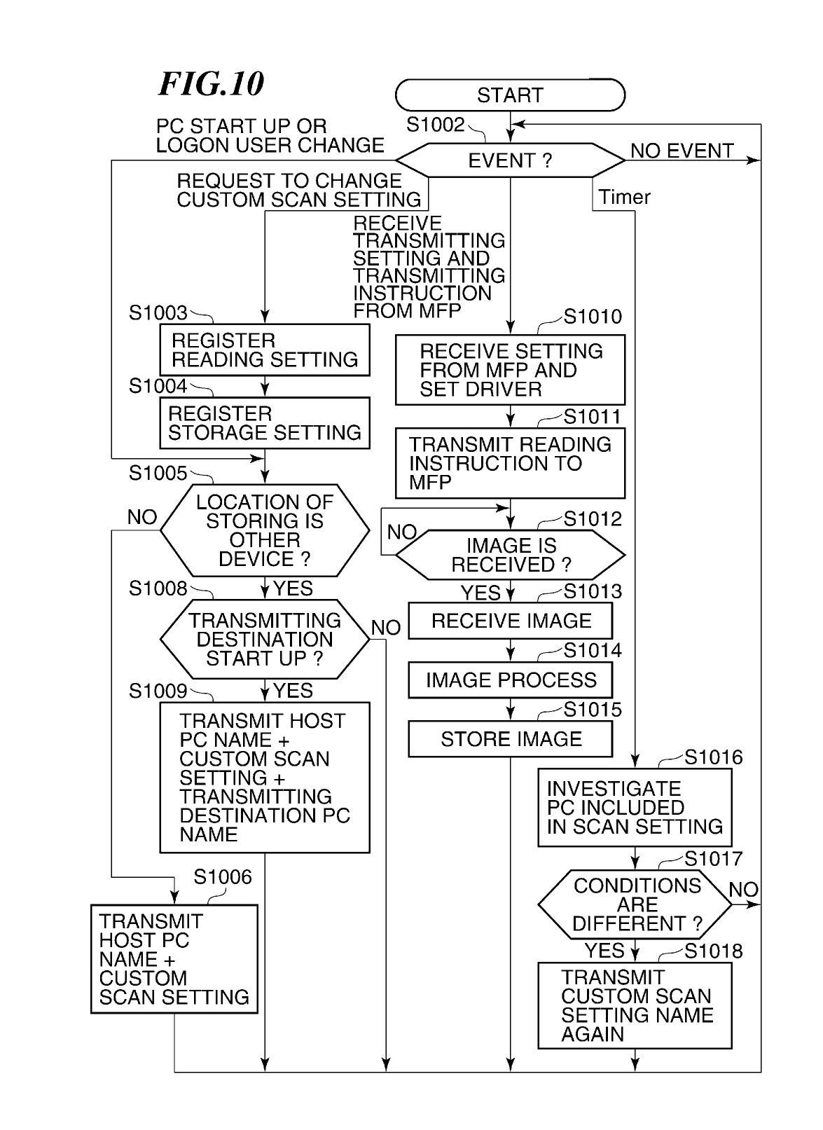

Next, an operation example of the host PC 103 will be described with reference to FIG. 10. Each process in FIG. 10 is achieved by loading a control program stored in a ROM, an HDD, or the like (not shown) of the host PC 103 onto a RAM (not shown) and by executing the program by the CPU (not shown). It is assumed that the pull scanning driver is installed in the HDD or the like of the host PC 103 beforehand.

The CPU waits for various events in step S1002. When the event is a custom-scan-setting change request on the pull scanning driver, the CPU proceeds with the process to step S1003. When the event is a start of the host PC 103 or a change of the logon user, the CPU proceeds with the process to step S1005. When the event is a notice to request of the pull scanning from the MFP 101 (receptions of the transmission request of the start indication of the pull scanning, and the custom scan setting name), the CPU proceeds with the process to step S1010. Further, when the event is a lapse of a predetermined time period, the CPU proceeds with the process to step S1016.

In the step S1003, the CPU registers the contents in the fields 606 through 610 of the “reading setting” in the screen in FIG. 6 that is changed by the user, stores it to the HDD etc., and proceeds with the process to step S1004.

In the step S1004, the CPU registers the contents in the fields 611 and 612 of the “storage setting” in the screen in FIG. 6 that is changed by the user, stores it to the HDD etc., and proceeds with the process to the step S1005.

In the step S1005, the CPU determines whether the field 611 of the “storage setting” (location of storing) in FIG. 6 is set to another device on the network. When setting to another device, the CPU proceeds with the process to step S1008. When not setting to another device, the CPU proceeds with the process to step S1006.

In the step S1006, the CPU transmits the host PC name and the custom scan setting name to the MFP 101 in order to make the MFP 101 generate the selection screen (FIG. 8) that is shown on the LCD unit 135 at the time of the pseudo-push scanning, and returns the process to the step S1002.

In the step S1008, the CPU determines whether the other device that is the destination storing the image (transmitting destination) has started. When it has started, the process proceeds to step S1009. When it has not started, the process returns to the step S1002.

In the step S1009, the CPU transmits the host PC name, the custom scan setting name, and the transmitting destination PC name to the MFP 101 in order to make the MFP 101 generate the selection screen (FIG. 8) that is shown on the LCD unit 135 at the time of the pseudo-push scanning, and returns the process to the step S1002. It should be noted that the CPU acquires the transmitting destination PC name from the device that is specified by the content inputted in the field 611 of the “storage setting” (location of storing) in FIG. 6, and transmits the transmitting destination PC name to the MFP 101.

On the other hand, in the step S1010, the CPU determines which of the custom scan settings assigned to the buttons 502 through 505 in FIG. 5 is used to start the pull scanning based an the custom scan setting names received, and proceeds with the process to step S1011.

In the step S1011, the CPU transmits a start instruction of the pull scanning to the MFP 101 based on the setting determined in the step S1010, and proceeds with the process to step S1012.

In the step S1012, the CPU waits for receiving the scan image transmitted from the MFP 101. When receiving the scan image, the process proceeds to step S1013.

In the step S1013, the CPU proceeds with the process to step S1014 after the reception of the scan image from the MFP 101 is completed.

In the step S1014, the CPU performs the image process to the scan image received based on the setting determined in the step S1010, and proceeds with the process to step S1015.

In the step S1015, the CPU stores the image with reference to the input contents in the field 611 of the “storage setting” (location of storing) and the field 612 of the “file name” in FIG. 6 from the custom scan setting name received in the step S1010, and returns to the step S1002.

In the step S1016, the CPU investigates whether the field 611 of the “storage setting” (location of storing) in the screen in FIG. 6 is set to another device on the network. When setting to another device, the CPU investigates whether the other device as the destination storing the image (transmitting destination) has started or shut down, and proceeds with the process to step S1017.

In the step S1017, the CPU determines whether the condition investigated in the step S1016 is different from the previous condition. When it is different, the process proceeds to step S1018. When it is not different, the process returns to the step S1002.

In the step S1018, the CPU transmits the custom scan setting name to the MFP 101 again according to the difference between the condition investigated in the step S1016 and the previous condition, and returns the process to the step S1002.

Specifically, when the other device alters from the shut-down condition to the start-up condition, the CPU transmits the key name to the MFP 101 again in order to make the MFP 101 display the custom scan setting name on the reading-setting screen 820 (FIG. 8) at the time of the pseudo-push scanning. When the other device alters from the start-up condition to the shut-down condition, the CPU transmits the instruction to delete the key name to the MFP 101 again in order to make the MFP 101 delete the custom scan setting name from the reading-setting screen 820 (FIG. 8).

As described above, in this embodiment, when selecting a transmitting (storing) destination of a scan image read with the pseudo-push scanning method, the LCD unit 135 of the MFP 101 displays the final transmitting (storing) destination of the image, i.e., the transmission path of the image, with the host PC 103.

Accordingly, since the user of the MFP 101 can easily recognize the final transmitting destination of the read scan image using the LCD unit 135, the mistake to transmit the image to a wrong transmitting destination can be prevented beforehand. Since the transmission path of the image is clearly shown on the LCD unit 135 of the MFP 101, it becomes easy to identify a problem when an error occurs.

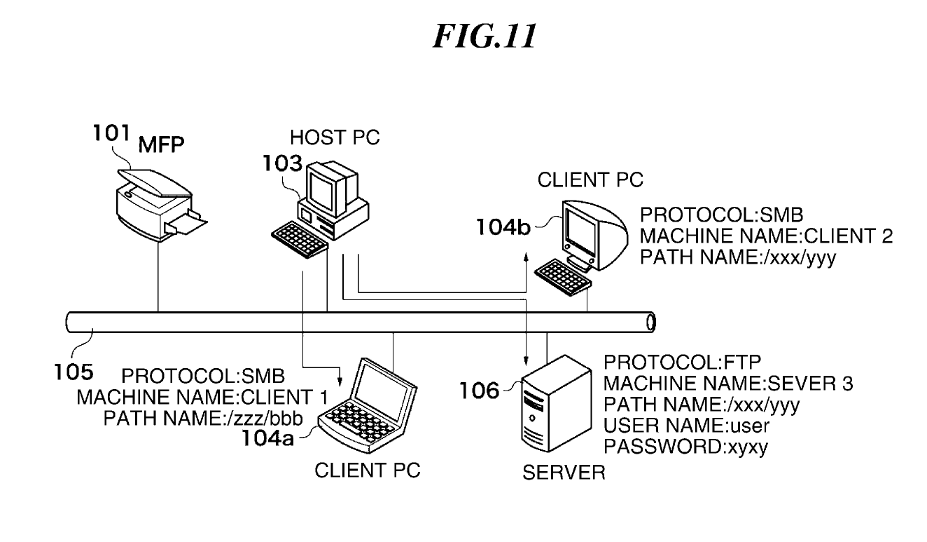

Next, an MFP that is an image processing apparatus of a second embodiment according to the present invention will be described with reference to FIG. 11 through FIG. 13. It should be noted that duplicated sections or corresponding section with respect to the above-mentioned first embodiment will be described by diverting the figures and the reference numerals.

As shown in FIG. 11, the host PC 103, a client PC 104a, a client PC 104b, and a server 106 are connected with the MFP 101 of this embodiment via the network 105 such as the LAN so as to enable mutual communication.

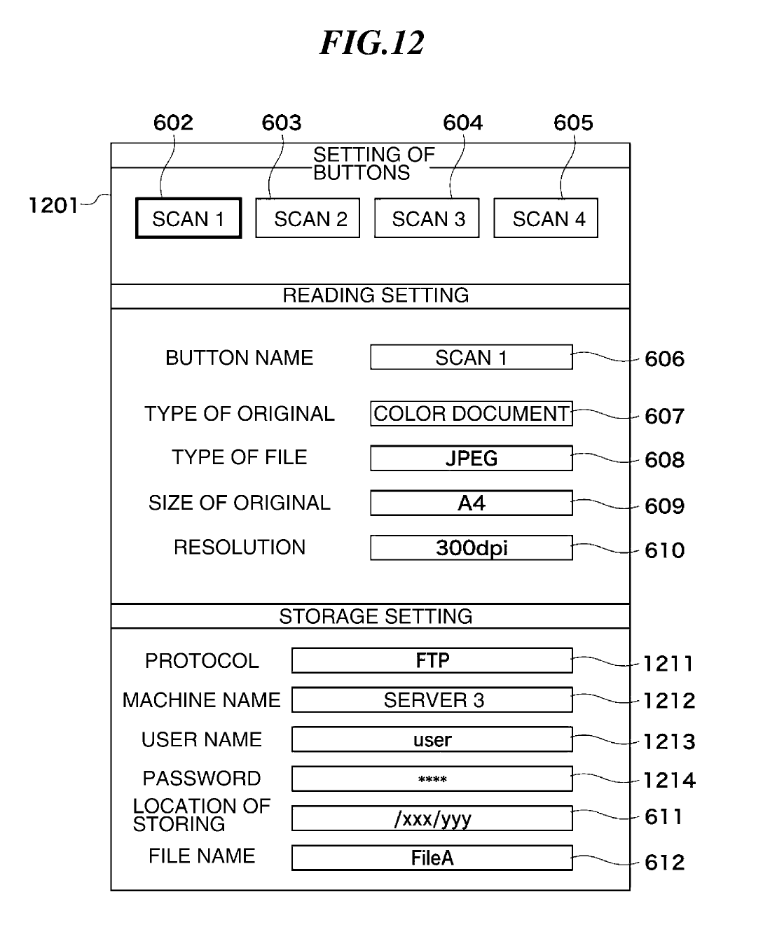

The host PC 103 supports a plurality of communication protocols, and can store an image using the plurality of communication protocols. Specifically, FIG. 12 shows an example of the screen 1201 of the custom scan setting of the pull scanning displayed on the display unit (not shown) of the host PC 103, and the screen 1201 includes fields 1211 through 1214 that are added to the screen 601 in FIG. 6.

The client PC 104a, the client PC 104b, and the server 106 may be a target to which the storage destination of an image is set up on the host PC 103. The client PC 104a, the client PC 104b, and the server 106 can store the images when the following values are inputted into the respective fields 1211 through 1214 and 611 of the “storage setting” in the screen 1201 in FIG. 12 and set up.

(Client PC 104a)

Field 1211 (protocol): SMB

Field 1212 (machine name): Client 1

Field 611 (location of storing): /zzz/bbb

(Client PC 104b)

Field 1211 (protocol): SMB

Field 1212 (machine name): Client 2

Field 611 (location of storing): /xxx/yyy

(Server 106)

Field 1211 (protocol): FTP

Field 1212 (machine name): Server 3

Field 1213 (user name): user

Field 1214 (password): xyxy

Field 611 (location of storing): /xxx/yyy

Here is an example where the client PC 104a is assigned to the “SCAN 1” of the button 602 in FIG. 12, the client PC 104b is assigned to the “SCAN 2” of the button 603 in FIG. 12, and the server 106 is assigned to the “SCAN 3” of the button 604 in FIG. 12.

Communication protocol information in the field 1211 of the “storage setting” in the screen 1201 in FIG. 12 is added to the information 721 in FIG. 7, and the communication protocol information is also added to generate the character string in the S904 in FIG. 9.

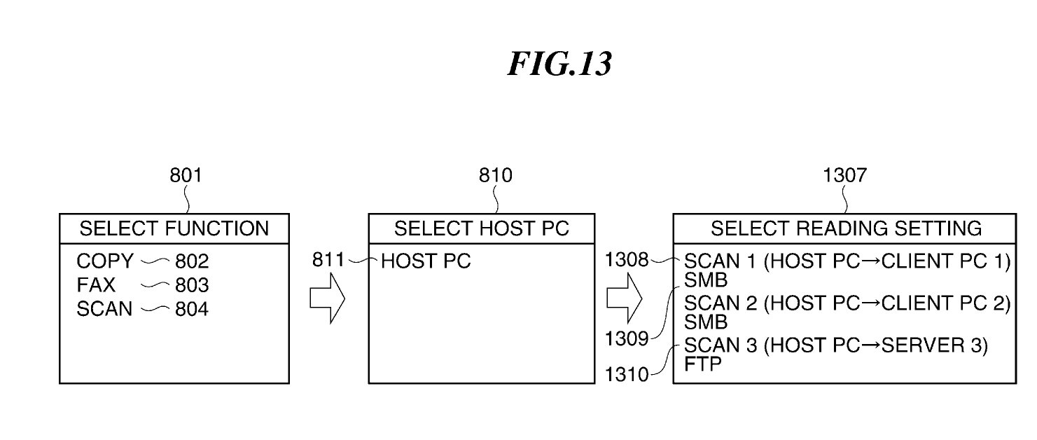

Accordingly, the communications protocols for the respective custom scan settings can be displayed on the LCD unit 135 of the MFP 101 as shown in the screen 1307 in FIG. 13. Here is an example where the information about the SCAN 1 is displayed as the item 1308, the information about the SCAN 2 is displayed as the item 1309, and the information about the SCAN 3 is displayed as the item 1310. According to this display, the user can know that the SCAN 1 and the SCAN 2 transfer image data using the SMB, and that the SCAN 3 transfers image data using the FTP. In addition, since a desired custom scan setting can be selected, the usability is improved more. The other configurations and operation effects are the same as that of the above-mentioned first embodiment.

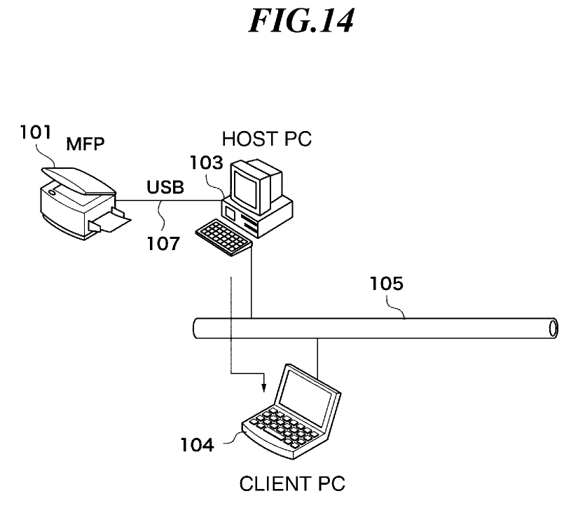

Next, an MFP that is an image processing apparatus of a third embodiment according to the present invention will be described with reference to FIG. 14. It should be noted that duplicated sections or corresponding section with respect to the above-mentioned first embodiment will be described by diverting the figures and the reference numerals.

The MFP 101 of this embodiment is connected with the host PC 103 via a wired USB or a wireless USB so as to enable communication. The host PC 103 is connected with the client PC 104 via the network 105 such as the LAN so as to enable communication. The other configurations and operation effects are the same as that of the above-mentioned first embodiment.

It should be noted that the present invention is not limited to the examples shown in the above-mentioned embodiments, and can be modified within a range that does not deviate from the outline of the present invention.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-094029, filed on Apr. 8, 2009, which is hereby incorporated by reference herein in its entirety.

What is claimed is:

1. An image processing apparatus comprising:
a display unit adapted to display a selection screen on which a user selects a scan setting and a transmitting destination of a scan image based on scan setting information and storage destination information about an image transmitted from an information processing apparatus;
a first transmission unit adapted to transmit the information selected on the selection screen and a transmitting request of reading-start-instruction information about the image to the image processing apparatus;
a reading unit adapted to read an image of an original in response to receiving the reading-start-instruction information transmitted from the information processing apparatus; and
a second transmission unit adapted to transmit a scan image of the original read by said reading unit to the information processing apparatus,
wherein the storage destination information about the image transmitted from the information processing apparatus includes information about the information processing apparatus and another device, when the scan image is transmitted from the information processing apparatus to the other device and stored,
wherein said display unit displays the information processing apparatus and the other device as the transmitting destination on the selection screen, when the storage destination information includes the information about the information processing apparatus and the other device.

2. The image processing apparatus according to claim 1, further comprising an image processing unit adapted to perform an image process to the scan image of the original read by said reading unit, and wherein said second transmitting unit transmits the scan image after performing the image process by said image processing unit to the information processing apparatus.

3. The image processing apparatus according to claim 1, wherein the storage destination information transmitted from the information processing apparatus includes communication protocol information between the information processing apparatus and the other device, and wherein said display unit displays the communication protocol information on the selection screen when the storage destination information includes the information about the information processing apparatus and the other device.

4. A control method for an image processing apparatus comprising:
a display step of displaying a selection screen on which a user selects a scan setting and a transmitting destination of a scan image based on scan setting information and storage destination information about an image transmitted from an information processing apparatus;
a first transmission step of transmitting the information selected on the selection screen and a transmitting request of reading-start-instruction information about the image to the image processing apparatus;
a reading step of reading an image of an original in response to receiving the reading-start-instruction information transmitted from the information processing apparatus; and
a second transmission step of transmitting a scan image of the original read in said reading step to the information processing apparatus,
wherein the storage destination information about the image transmitted from the information processing apparatus includes information about the information processing apparatus and another device, when the scan image is transmitted from the information processing apparatus to the other device and stored,
wherein said display step displays the information processing apparatus and the other device as the transmitting destination on the selection screen, when the storage destination information includes the information about the information processing apparatus and the other device.

5. A computer-readable storage medium storing a control program executing a control method for an information processing apparatus, said control method comprising:
a display step of displaying a selection screen on which a user selects a scan setting and a transmitting destination of a scan image based on scan setting information and storage destination information about an image transmitted from an information processing apparatus;
a first transmission step of transmitting the information selected on the selection screen and a transmitting request of reading-start-instruction information about the image to the image processing apparatus;
a reading step of reading an image of an original in response to receiving the reading-start-instruction information transmitted from the information processing apparatus; and
a second transmission step of transmitting a scan image of the original read in said reading step to the information processing apparatus,
wherein the storage destination information about the image transmitted from the information processing apparatus includes information about the information processing apparatus and another device, when the scan image is transmitted from the information processing apparatus to the other device and stored,
wherein said display step displays the information processing apparatus and the other device as the transmitting destination on the selection screen, when the storage destination information includes the information about the information processing apparatus and the other device.
